(19) United States
(12) Patent Application Publication
(10) Pub. No.: US 2026/0131859 A1
(43) Pub. Date: May 14, 2026

(54) OFF-ROAD VEHICLE AND SIDE SILL STRUCTURE

(71) Applicant: KAWASAKI MOTORS, LTD., Akashi-shi (JP)

(72) Inventors: Kenta TAKADA, Akashi-shi (JP); Rintaro SHO, Akashi-shi (JP)

(73) Assignee: KAWASAKI MOTORS, LTD., Akashi-shi (JP)

(21) Appl. No.: 19/389,068

(22) Filed: Nov. 14, 2025

(30) Foreign Application Priority Data
Nov. 14, 2024 (JP) 2024-199155

(51) Int. Cl. B62D 21/18; B62D 25/02

(52) U.S. Cl. CPC B62D 21/183; B62D 25/025

(57) ABSTRACT

A utility vehicle includes a seat, a floor wall positioned in front of the seat, a frame bar at least partially located outside the floor wall in a vehicle width direction and extending in a front-rear direction, and an inner wall covering the frame bar from the inside in the vehicle width direction, the inner wall has an inclined portion standing upward of the floor wall, and the inclined portion includes a lower portion and an upper portion located adjacent to the lower portion and extending, as compared to the lower portion, more outward in the vehicle width direction while extending upward.

### CROSS-REFERENCE TO RELATED APPLICATION

This application claims priority to Japanese Patent Application No. 2024-199155 filed on Nov. 14, 2024. The entire contents disclosed in this Japanese patent application, which includes the specification, the drawings, and the claims, are incorporated by reference herein.

### FIELD

The technique disclosed here relates to an off-road vehicle.

### BACKGROUND

U.S. Patent Application Publication No. 2016/0288686 discloses a vehicle having a side sill positioned below a closed door.

### BRIEF DESCRIPTION OF THE DRAWINGS

FIG. 1 is a left side view of a utility vehicle.

FIG. 2 is a perspective view showing, from above, the inside of a vehicle on a left front seat side.

FIG. 3 is an enlarged view of a side sill structure of FIG. 2.

FIG. 4 is a sectional view taken along IV-IV line of FIG. 3.

FIG. 5 is a sectional view taken along V-V line of FIG. 3.

FIG. 6 is a perspective view showing, from a frame bar side, a floor wall and an inner wall.

FIG. 7 is a schematic view showing a foot movement path in a side sill structure of a comparative example.

FIG. 8 is a schematic view showing a foot movement path in the side sill structure of the embodiment.

FIG. 9 is a schematic sectional view showing a side sill structure according to a first modification.

### DESCRIPTION OF EMBODIMENTS

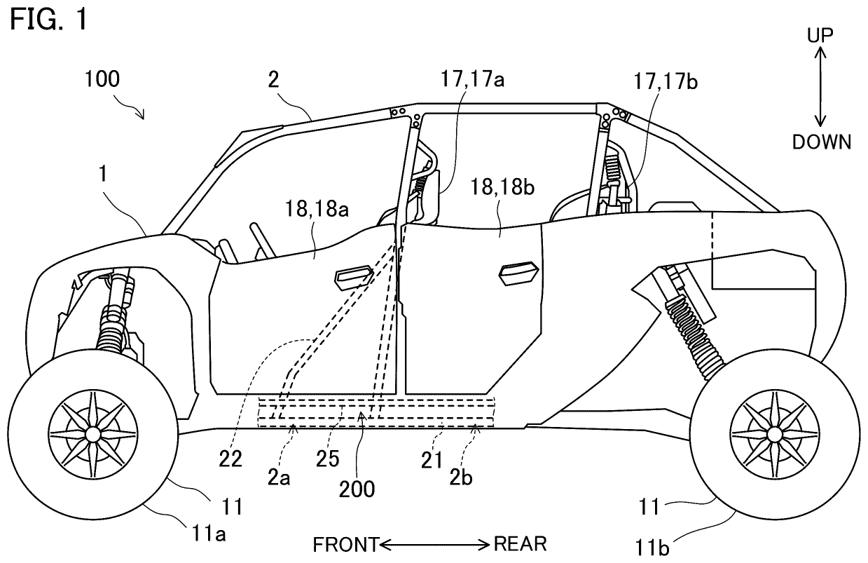

Hereinafter, an exemplary embodiment will be described in detail with reference to the drawings. FIG. 1 is a left side view of a utility vehicle 100. The utility vehicle 100 can travel off road. The utility vehicle 100 is one example of an off-road vehicle. Hereinafter, the utility vehicle 100 will also be referred to as a “vehicle 100”. The utility vehicle has, for example, a loading platform, a roll over protective structure (ROPS), or a low-pressure tire. The utility vehicle is, for example, a side by side vehicle.

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. A “vehicle width direction” means the width direction of the vehicle 100, and in other words, means the right-left direction of the vehicle 100 and will also be referred to as a “right-left direction”. An “inside in the vehicle width direction” means a vehicle interior side in the vehicle width direction, and an “outside in the vehicle width direction” means a vehicle outer side in the vehicle width direction. The vehicle 100 includes a body 1, a vehicle body frame 2, a wheel 11, a seat 17 on which an occupant sits, and a door 18. The wheel 11 includes right and left front wheels 11a and right and left rear wheels 11b. That is, the vehicle 100 is a four-wheeled vehicle. Note that in a case where the front wheels 11a and the rear wheels 11b are not distinguished from each other, these wheels will be merely referred to as a “wheel(s) 11”.

The seat 17 includes a front seat 17a and a rear seat 17b positioned in rear of the front seat 17a. In this example, the seat 17 includes two front seats 17a aligned in the right-left direction and two rear seats 17b aligned in the right-left direction. Note that in a case where the front seats 17a and the rear seats 17b are not distinguished from each other, these seats will be merely referred to as a “seat(s) 17”. A floor on which the feet of the occupant are located is in front of the seat 17. The floor is at a position lower than the seat surface of the seat 17.

The door 18 includes a front door 18a and a rear door 18b positioned in rear of the front door 18a. In this example, the door 18 includes two front doors 18a located on the right and left sides and two rear doors 18b located on the right and left sides. Note that in a case where the front doors 18a and the rear doors 18b are not distinguished from each other, these doors will be merely referred to as a “door(s) 18”.

The vehicle 100 travels on an unpaved uneven ground in some cases. The vehicle 100 traveling on the uneven ground may stop in a state on a rock or the like or a state of tilting right and left. When the occupant gets on and off the vehicle, the floor inside the vehicle may tilt with respect to the ground outside the vehicle, or may be at a position higher than the ground. In this case, the occupant may need to lift the foot higher as compared to a case of the vehicle stopping on an even ground.

In order to increase the scope of uneven areas where the vehicle 100 can travel and prevent contact between an obstacle protruding from the ground and the bottom surface of the vehicle, the vehicle 100 has a great minimum ground clearance. Thus, in some cases, a frame positioned outside the seat 17 in the vehicle width direction is at a position higher than the floor inside the vehicle. Moreover, in order to increase the scope of uneven areas where the vehicle 100 can travel and prevent contact between obstacles on both sides of the vehicle in the vehicle width direction and the side surfaces of the vehicle, the vehicle 100 has a relatively-small dimension in the vehicle width direction in some cases. Thus, in some cases, the frame positioned outside the seat 17 in the vehicle width direction is positioned close to the floor inside the vehicle in the vehicle width direction.

The vehicle body frame 2 includes a front frame 2a and a rear frame 2b. The front seat 17a is located on the front frame 2a. The rear seat 17b is located on the rear frame 2b. Specifically, the vehicle body frame 2 includes a bottom frame 21, a side frame 22, and a frame bar 25.

The bottom frame 21 is located at the bottom of the vehicle body frame 2. The bottom frame 21 is in a frame shape extending in the front-rear direction and the vehicle width direction. The bottom frame 21 is located lower than the floor. The bottom frame 21 supports the floor.

The side frame 22 includes side frames 22 located on the right and left sides of the vehicle body frame 2. The side frame 22 is coupled to the bottom frame 21, and extends upward of the bottom frame 21. The side frame 22 extends outward of the bottom frame 21 in the vehicle width direction. The front end of the side frame 22 is positioned in rear of the front end of the front seat 17a. The side frame 22 supports a side portion of a vehicle body. The side frame 22 is also connected to the frame bar 25.

The frame bar 25 includes frame bars 25 located on the right and left sides of the vehicle body frame 2. The frame bar 25 is located on the front frame 2a and the rear frame 2b. The frame bar 25 is located higher than the bottom frame 21 and outside the bottom frame 21 in the vehicle width direction. The frame bar 25 extends in the front-rear direction. The frame bar 25 is coupled to the side frame 22 and the bottom frame 21.

The frame bar 25 is positioned higher than the floor and lower than the seat surface of the seat 17. The frame bar 25 is positioned outside the seat 17 in the vehicle width direction.

The frame bar 25 is covered from above with a side sill structure 200 as a cover member. A lower portion of the door 18 contacts the side sill structure 200, and in this manner, a gap between the lower portion of the door 18 and the vehicle body can be prevented.

When getting on the vehicle, the occupant lifts the foot higher than the frame bar 25, lowers the foot, and then causes the bottom of the foot to contact the floor.

Alternatively, when getting on the vehicle, the occupant places the foot on the side sill structure 200 covering the frame bar 25 from above, lowers the foot, and then causes the bottom of the foot to contact the floor.

Since the frame bar 25 is located higher than the floor, a bottom portion of the vehicle below the frame bar 25 can be at a relatively-high position. With this configuration, contact with an obstacle can be easily prevented below the frame bar 25.

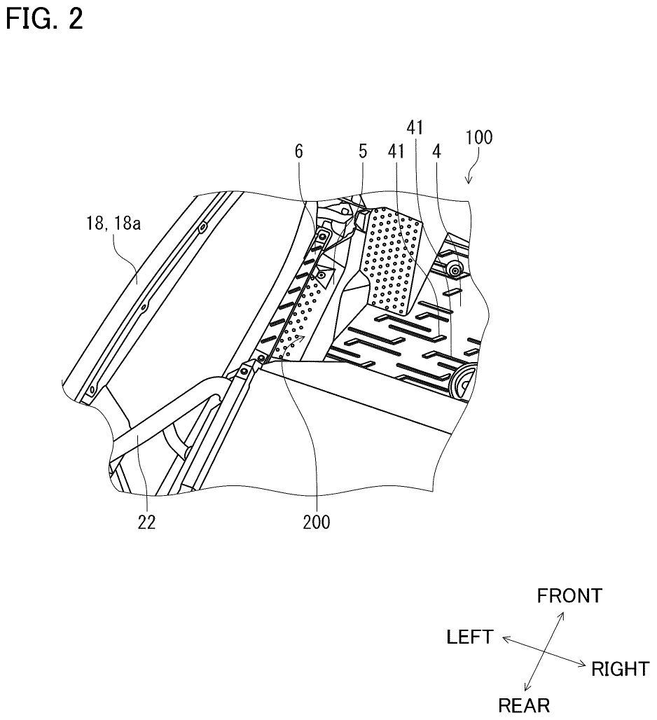

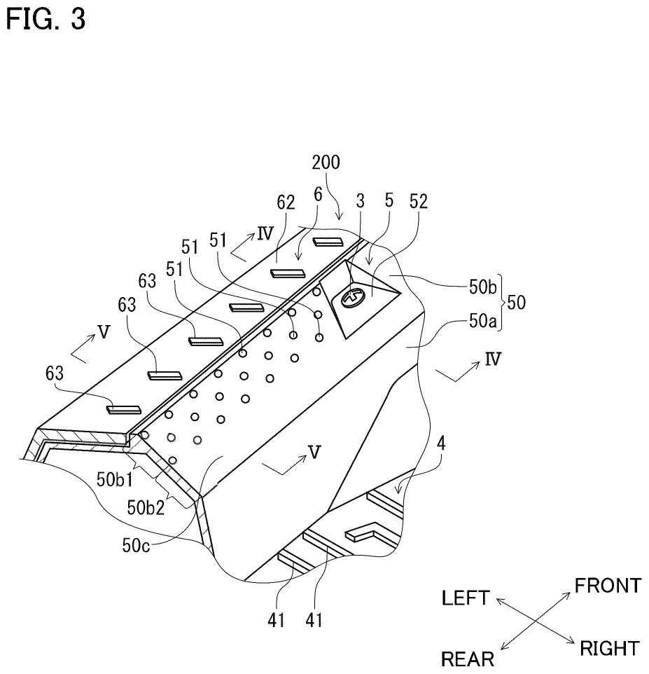

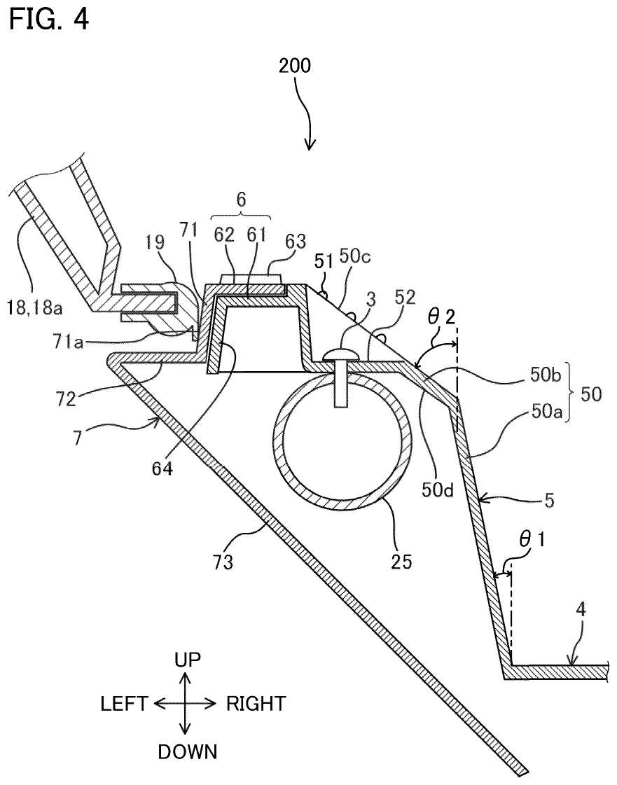

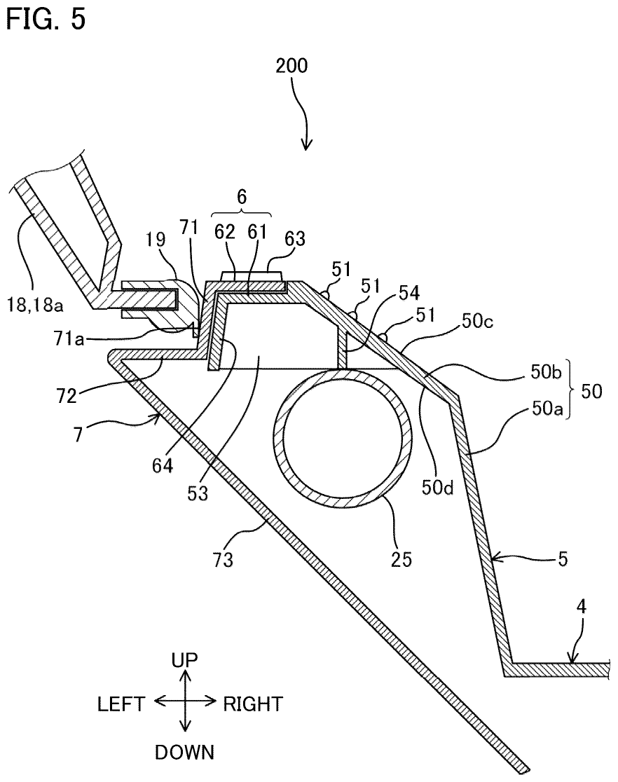

FIG. 2 is a perspective view showing, from above, the inside of the vehicle on the left front seat 17a side. FIG. 3 is an enlarged view of the vicinity of the side sill structure 200 of FIG. 2. FIG. 4 is a sectional view taken along IV-IV line of FIG. 3. FIG. 5 is a sectional view taken along V-V line of FIG. 3. Note that in FIG. 2, the front seat 17a is not shown.

The vehicle 100 further includes a floor wall 4 and the side sill structure 200 located outside the floor wall 4 in the vehicle width direction. The side sill structure 200 is positioned outside the seat 17 in the vehicle width direction. The side sill structure 200 has an inner wall 5 standing upward of the floor wall 4 on the outside of the floor wall 4 in the vehicle width direction, an upper wall 6 extending outward of the inner wall 5 in the vehicle width direction, and an outer wall 7 extending downward of the upper wall 6 on the outside of the upper wall 6 in the vehicle width direction.

The floor wall 4 is positioned in front of the seat 17. The floor wall 4 is a portion with which the bottom of the foot of the occupant contacts when the occupant sits on the seat 17. The floor wall 4 is positioned inside the frame bar 25 in the vehicle width direction. The upper surface of the floor wall 4 is positioned lower than the upper end of the frame bar 25. The upper surface of the floor wall 4 includes the floor. The floor wall 4 extends in the vehicle width direction from the inner end of the seat 17 in the vehicle width direction to the outer end of the seat 17 in the vehicle width direction. For example, the floor wall 4 may extend horizontally, or may be partially inclined with respect to the horizontal plane. In FIG. 2, the floor wall 4 is positioned in front of the front seat 17a. The floor wall 4 is supported by the bottom frame 21. The floor wall 4 includes protrusions 41. The protrusion 41 reduces slipping of the bottom of the foot of the occupant. The protrusion 41 extends in the vehicle width direction to reduce slipping of the bottom of the foot on the floor wall 4 in the front-rear direction.

In the present embodiment, the side sill structure 200 is located below the closed door 18. Specifically, the side sill structure 200 includes side sill structures 200 located below the right and left front doors 18a and below the right and left rear doors 18b. The side sill structure 200 covers the frame bar 25.

The inner wall 5 covers the frame bar 25 from the inside in the vehicle width direction. At least part of the frame bar 25 is located outside the floor wall 4 in the vehicle width direction.

The inner wall 5 has an inclined portion 50 standing upward of the floor wall 4. The inclined portion 50 extends outward in the vehicle width direction while extending upward. The inclined portion 50 is connected to an outer end portion of the floor wall 4 in the vehicle width direction. The inclined portion 50 includes a lower portion 50a and an upper portion 50b. The lower portion 50a is connected to the floor wall 4. The upper portion 50b is adjacent to the lower portion 50a thereabove. Each of the lower portion 50a and the upper portion 50b is not perpendicular to the horizontal plane, and is inclined with respect to the horizontal plane. The upper portion 50b extends more outward in the vehicle width direction while extending upward, as compared to the lower portion 50a. That is, the inclination of the upper portion 50b with respect to the horizontal plane is smaller than the inclination of the lower portion 50a with respect to the horizontal plane. In other words, as shown in FIG. 4, an angle θ2 between the vertical plane and the inner surface of the upper portion 50b in the vehicle width direction is greater than an angle θ1 between the vertical plane and the inner surface of the lower portion 50a in the vehicle width direction.

Part of the lower portion 50a and the upper portion 50b overlap with the frame bar 25 in the vehicle width direction. The upper portion 50b overlaps with the frame bar 25 in the up-down direction. In the present embodiment, the upper portion 50b is positioned in a region from the upper end position of the frame bar 25 in a cylindrical shape to the intermediate position thereof in the up-down direction. The lower portion 50a is positioned below the intermediate position of the frame bar 25 in the up-down direction.

The lower portion 50a and the upper portion 50b are in a flat plate shape. Note that at least one of the lower portion 50a or the upper portion 50b may be configured such that the inner surface thereof in the vehicle width direction is in a curved shape recessed outward in the vehicle width direction. That is, at least one of the lower portion 50a or the upper portion 50b may be in a shape projecting toward the frame bar 25. Alternatively, at least one of the lower portion 50a or the upper portion 50b may be in a shape projecting toward the frame bar 25.

The inclined portion 50 at least partially includes an inclination-side protrusion 51 as a recessed-projecting shape. In this example, the inclined portion 50 includes inclination-side protrusions 51 protruding upward as compared to the remaining portion. The inclination-side protrusions 51 and the surface of the remaining portion define the recessed-projecting shape. The inclination-side protrusion 51 is located on the upper surface 50c of the inclined portion 50. The upper surface 50c of the inclined portion 50 is a surface positioned on the side opposite to the frame bar 25, i.e., a surface facing inward in the vehicle width direction.

The inclination-side protrusions 51 are aligned at intervals in the front-rear direction. The inclination-side protrusions 51 are aligned at intervals in the right-left direction. The inclination-side protrusions 51 adjacent to each other in the right-left direction are at positions shifted in the front-rear direction. That is, the inclination-side protrusions 51 are located in a staggered shape.

In the present embodiment, the shape of the inclination-side protrusion 51 is a substantially hemispherical shape. For example, the inclination-side protrusions 51 are located at intervals in a region of 50 mm in the front-rear direction and 50 mm in the right-left direction. With this configuration, the bottom of the foot easily contacts the inclination-side protrusions 51 when contacting the inclined portion 50. Note that the shape of the inclination-side protrusion 51 may be other shapes such as a conical shape, a pyramid shape, or a rectangular parallelepiped shape.

The upper portion 50b of the inclined portion 50 includes a recessed-projecting region 50b1 and a flat region 50b2. The recessed-projecting region 50b1 is positioned in an upper portion of the upper surface 50c. The recessed-projecting region 50b1 is in a recessed-projecting shape. The flat region 50b2 is positioned in a lower portion of the upper surface 50c. The flat region 50b2 is a flatter shape than that of the recessed-projecting region 50b1. In the present embodiment, the upper surface of the flat region 50b2 is in a flat surface shape along the inclination without the above-described inclination-side protrusion 51. Specifically, the recessed-projecting region 50b1 includes the inclination-side protrusion 51. The flat region 50b2 includes no inclination-side protrusion 51.

The surface of the inclined portion 50 is a texture surface. The texture surface is a surface roughened by chemical treatment and finished with recesses and projections. The chemical treatment is, for example, etching. The texture surface is also referred to as a “satin finished surface”. The member including the inclined portion 50 is made of synthetic resin containing a coloring material.

The inner wall 5 includes a recess 52 recessed downward of the upper surface 50c of the inclined portion 50. That is, the recess 52 protrudes downward of the lower surface 50d of the inclined portion 50. The lower surface 50d of the inclined portion 50 is a surface positioned on the frame bar 25 side. The downward direction is a direction toward the frame bar 25 side, i.e., the lower surface 50d is a surface facing outward in the vehicle width direction. The recess 52 is positioned in the upper portion 50b of the inclined portion 50. Specifically, the recess 52 is positioned in the recessed-projecting region 50b1.

A fastener 3 is located in the recess 52. The fastener 3 fastens the inner wall 5 to the frame bar 25. The fastener 3 is, for example, a screw member. In a state of the lower surface 50d of the recess 52 of the inclined portion 50 contacting the frame bar 25, the fastener 3 penetrates the inner wall 5 and the frame bar 25, and fastens the inner wall 5 to the frame bar 25.

The recess 52 is retracted downward as compared to the remaining portion of the upper surface 50c of the inclined portion 50. That is, the fastener 3 positioned in the recess 52 has a smaller amount of upward protrusion from the upper surface 50c of the inclined portion 50 as compared to a case of being located at a position other than the recess 52. In the present embodiment, the amount of retraction of the recess 52 is greater than the height of the fastener 3. With this configuration, the upper end of the fastener 3 is positioned lower than the upper surface 50c of the inclined portion 50.

The fastener 3 is positioned at the upper portion 50b of the inclined portion 50.

Specifically, the fastener 3 is positioned in the recessed-projecting region 50b1.

The dimensions of at least the upper portion 50b of the inclined portion 50 in the up-down direction and the right-left direction are greater than the thickness dimension of the member of the inner wall 5. At least one of the dimensions of at least the upper portion 50b of the inclined portion 50 in the up-down direction and the right-left direction is greater than the radius dimension of the frame bar 25. The dimension of at least the upper portion 50b of the inclined portion 50 in the up-down direction is greater than the dimension of the recess 52 in the up-down direction.

The upper wall 6 is adjacent to the outside of the inclined portion 50 in the vehicle width direction. The upper wall 6 is inclined smaller than the inclined portion 50. In the present embodiment, the upper surface of the upper wall 6 extends horizontally. Specifically, the upper wall 6 is inclined smaller than the upper portion 50b of the inclined portion 50. As shown in FIG. 4, in the present embodiment, the upper wall 6 extends horizontally outward in the vehicle width direction from the outer end of the inclined portion 50 in the vehicle width direction.

The upper wall 6 includes a first portion 61 and a second portion 62. The first portion 61 and the second portion 62 extend horizontally. The second portion 62 overlaps with the first portion 61 thereabove. The second portion 62 partially covers the upper surface of the first portion 61. The first portion 61 is connected to an outer end portion of the inclined portion 50 in the vehicle width direction. In other words, the first portion 61 is a member integrated with the inner wall 5. The second portion 62 is a member integrated with the outer wall 7. The outer wall 7 is coated and colored with a paint. The first portion 61 and the second portion 62 may be fastened together when the second portion 62 is connected to the vehicle body frame 2. A flange 64 is connected to the first portion 61. The flange 64 is connected to an outer end portion of the first portion 61 in the vehicle width direction. The flange 64 extends downward of the first portion 61.

An inner portion of the first portion 61 in the vehicle width direction protrudes upward as compared to the remaining portion of the first portion 61. The second portion 62 overlaps with the first portion 61 from above on the outside in the vehicle width direction with respect to an inner portion of the first portion 61 in the vehicle width direction.

The portion of the first portion 61 overlapping with the second portion 62 is recessed downward of the inner portion of the first portion 61 in the vehicle width direction. With this configuration, a step between the first portion 61 and the second portion 62 in the up-down direction can be reduced in size. For example, the portion of the first portion 61 overlapping with the second portion 62 is recessed downward by an amount corresponding to the thickness of the second portion 62, so that the step between the first portion 61 and the second portion 62 can be eliminated.

The upper wall 6 at least partially includes an upper-wall-side protrusion 63 as a recessed-projecting shape. In this example, the upper wall 6 includes upper-wall-side protrusions 63. The upper-wall-side protrusions 63 and the surface of the remaining portion define the recessed-projecting shape. The upper-wall-side protrusion 63 is located on the upper surface of the upper wall 6. Specifically, the upper-wall-side protrusion 63 is located on the upper surface of the second portion 62. Moreover, the upper-wall-side protrusion 63 is located on the upper surface of the first portion 61 not overlapping with the second portion 62. The upper-wall-side protrusions 63 are aligned in the front-rear direction.

The upper-wall-side protrusion 63 has a shape different from that of the inclination-side protrusion 51. Specifically, the upper-wall-side protrusion 63 on the second portion 62 is greater in a dimension in the front-rear direction than the inclination-side protrusion 51. The shape of the upper-wall-side protrusion 63 is a rectangular parallelepiped shape. The longitudinal direction of the upper-wall-side protrusion 63 is inclined with respect to the front-rear direction and the right-left direction in plan view. Note that the shape of the upper-wall-side protrusion 63 may be other shapes such as a hemispherical shape, a conical shape, or a pyramid shape.

The upper-wall-side protrusion 63 on the outside in the vehicle width direction is greater in a dimension in the right-left direction than the inclination-side protrusion 51 on the inside in the vehicle width direction. With this configuration, resistance when the bottom of the foot contacts the upper-wall-side protrusion 63 can be reduced, and the foot can easily move while the bottom of the foot is sliding in contact with the upper-wall-side protrusion 63. Moreover, the upper-wall-side protrusion 63 on the outside in the vehicle width direction is greater in a dimension in the front-rear direction than the inclination-side protrusion 51 on the inside in the vehicle width direction. With this configuration, even if there is a gap between the upper-wall-side protrusion 63 and the door 18 in the up-down direction, the upper-wall-side protrusion 63 more easily reduces entrance of a foreign substance into the vehicle as compared to the case of a small upper-wall-side protrusion 63.

The outer wall 7 covers the frame bar 25 from the outside in the vehicle width direction. The outer wall 7 includes a step 71, a bulge 72, and a cover 73.

The step 71 extends downward of the upper wall 6 on the outside of the upper wall 6 in the vehicle width direction. The step 71 extends in the vertical direction.

Specifically, the step 71 is connected to an outer end portion of the second portion 62 in the vehicle width direction. The step 71 is positioned outside the frame bar 25 in the vehicle width direction. The step 71 faces the outside of the flange 64 in the vehicle width direction.

The bulge 72 extends outward of the step 71 in the vehicle width direction. The bulge 72 extends horizontally. Specifically, the bulge 72 is connected to a lower end portion of the step 71.

The cover 73 extends downward of the bulge 72 on the outside of the bulge 72 in the vehicle width direction. Specifically, the cover 73 is connected to an outer end portion of the bulge 72 in the vehicle width direction. The cover 73 extends inward in the vehicle width direction while extending downward. The cover 73 extends to below the floor wall 4.

The step 71 includes a seal surface 71a. The seal surface 71a seal-contacts the door 18 in a state of the door 18 being closed. The seal surface 71a faces outward in the vehicle width direction. The seal surface 71a is positioned outside the frame bar 25 in the vehicle width direction.

Specifically, the door 18 has, at a lower end portion thereof, a seal member 19. The seal member 19 is located in a space defined by the step 71 and the bulge 72 in a state of the door 18 being closed. In this state, the seal member 19 contacts the seal surface 71a.

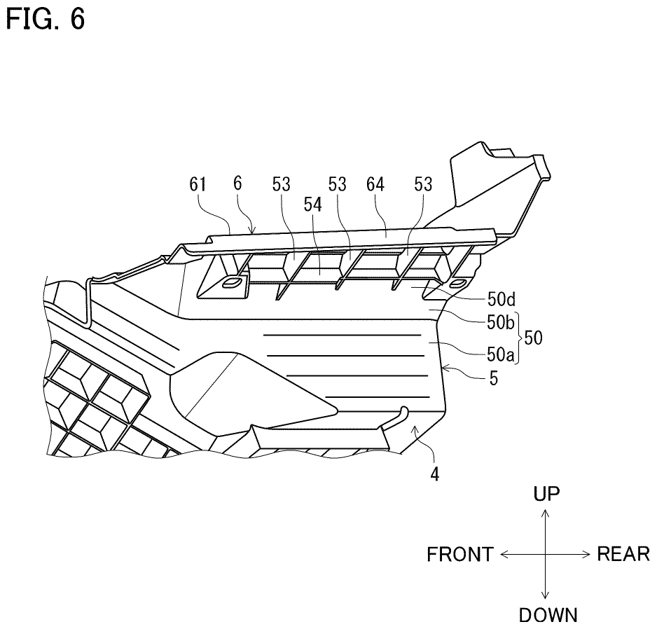

FIG. 6 is a perspective view showing, from the frame bar 25 side, the floor wall 4 and the inner wall 5. As shown in FIGS. 5 and 6, the inclined portion 50 includes, on the lower surface 50d, a first rib 53 and a second rib 54 extending downward.

Specifically, the inclined portion 50 includes first ribs 53 and one second rib 54.

The first rib 53 extends in the vehicle width direction. The first ribs 53 are located at intervals in the front-rear direction. The first rib 53 faces the frame bar 25, and is connected to the upper portion 50b of the inclined portion 50, the first portion 61 of the upper wall 6, and the flange 64.

The second rib 54 extends in the front-rear direction. The second rib 54 crosses the first ribs 53. The second rib 54 faces the frame bar 25, and is connected to the upper portion 50b of the inclined portion 50.

The inclined portion 50 includes a reinforcement contacting the frame bar 25 from above. The reinforcement includes the first rib 53 and the second rib 54 in this example. Specifically, the first rib 53 contacts the frame bar 25 at an intersection between the first rib 53 and the second rib 54. The second rib 54 contacts the frame bar 25 in the front-rear direction.

The surface of the inner wall 5 is made of a material less slippable than the surface of the outer wall 7. Specifically, the material of the surface of the inner wall 5 is, for example, polypropylene (PP). Polypropylene is a less-slippable material than polyethylene (PE) which is the material of the outer wall 7. With this configuration, the foot is less likely to slip even when the occupant places the bottom of the foot on the inner wall 5.

The material of the surface of the outer wall 7 is, for example, polyethylene, and is preferably high density polyethylene (HDPE). Polyethylene is a more-slippable more-deformable material than polypropylene which is the material of the inner wall 5. Since polyethylene is more slippable, the outer wall 7 is less likely to receive frictional force from an obstacle such as a rock and be damaged even when the obstacle contacts the outer wall 7 while the vehicle is traveling. Moreover, since polyethylene is more deformable, the outer wall 7 is more likely to absorb impactive force from the obstacle and is less likely to be damaged even when the obstacle contacts the outer wall 7.

Specifically, the floor wall 4, the inner wall 5, the first portion 61 of the upper wall 6, and the flange 64 are integrated into an inner panel. The outer wall 7 and the second portion 62 of the upper wall 6 are integrated into an outer panel. The surface of the inner panel is less slippable than the surface of the outer panel. The material of the surface of the inner wall 5 is, for example, polypropylene, and the material of the surface of the outer wall 7 is, for example, polyethylene.

According to the above-described vehicle 100 and the above-described side sill structure 200, the inclined portion 50 of the inner wall 5 includes the lower portion 50a and the upper portion 50b extending, as compared to the lower portion 50a, more outward in the vehicle width direction while extending upward. With this configuration, when the occupant in the vehicle moves the foot over the inner wall 5 to get off the vehicle, the amount of lifting of the foot can be reduced as compared to the case of no inclined portion 50. Thus, a foot movement path is shortened, and ease of getting on and off the vehicle is improved.

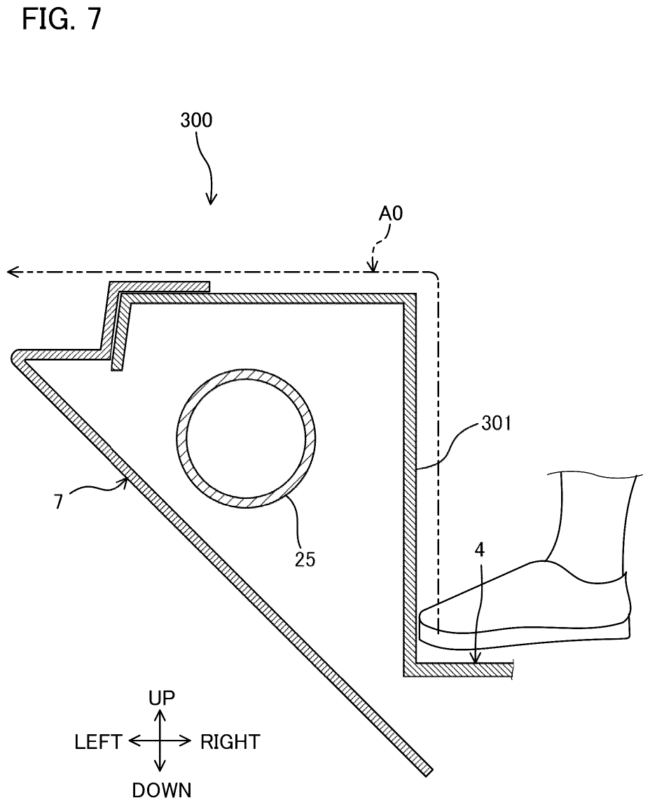

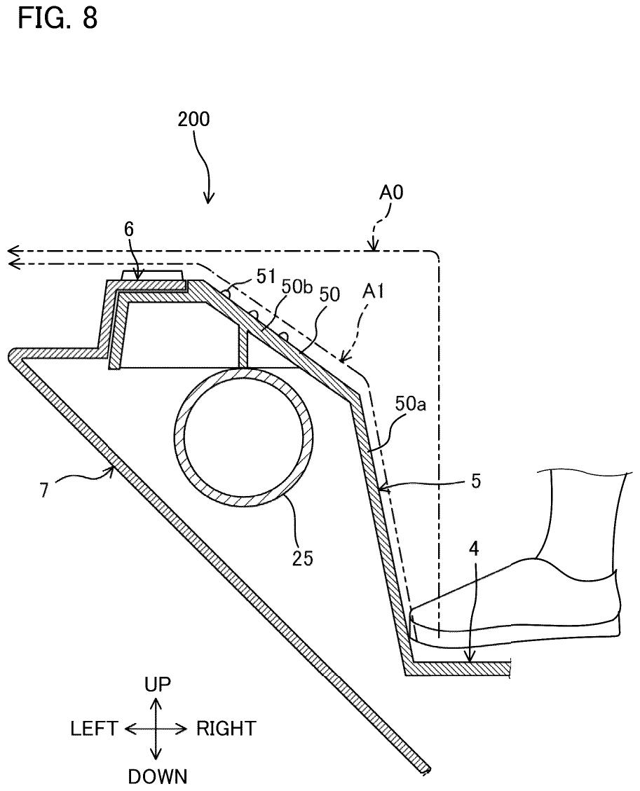

FIG. 7 is a schematic view showing a foot movement path in a side sill structure 300 of a comparative example. In a case where there is no inclined portion of the present disclosure, specifically a case where there is a vertical portion 301 standing upward of the floor wall 4, when the occupant moves the foot over the side sill structure 300 to get off the vehicle, the foot contacts the vertical portion if the occupant attempts to move the foot a shot distance. For this reason, as indicated by a dash-dot-dot arrow A0, the foot movement path is long. Since the foot is lifted higher and the movement path thereof is long, a process of getting off the vehicle is difficult to be performed. FIG. 8 is a schematic view showing the foot movement path in the side sill structure 200 of the embodiment. In the present disclosure, the inclined portion 50 of the inner wall 5 includes the lower portion 50a and the upper portion 50b extending, as compared to the lower portion 50a, more outward in the vehicle width direction while extending upward. When the occupant moves the foot over the side sill structure 200 to get off the vehicle, contact with the inner wall 5 can be prevented even if the occupant moves the foot a short distance. That is, as indicated by a dash-dot-dot arrow A1, the foot movement path is shorter than that in the case indicated by the dash-dot-dot arrow A0 in the comparative example. Thus, the foot movement path is shortened, and a process of getting off the vehicle is easily performed.

When the occupant gets on the vehicle, the foot movement path can be similarly shortened, and the ease of getting on and off the vehicle can be achieved. In a case where the off-road vehicle is positioned on the uneven ground, various postures of the stopped vehicle with respect to the ground when the occupant gets on and off the vehicle are assumed. Thus, for the off-road vehicle, the ease of getting on and off the vehicle is desired. For example, depending on the posture of the stopped vehicle, such as a case where the vehicle stops on the inclined ground, a foot movement distance from the ground surface to the floor may be long. With the above-described inclined portion 50 of the present disclosure, the foot movement path can be shortened and the occupant can easily get on and off the vehicle even in this case.

Since the inclined portion 50 of the inner wall 5 includes the lower portion 50a and the upper portion 50b extending, as compared to the lower portion 50a, more outward in the vehicle width direction while extending upward, a legroom in the vehicle is expanded as compared to a case where the inner wall 5 includes the vertical portion standing upward of the floor wall 4.

Since the inclined portion 50 includes the inclination-side protrusion 51, when the occupant places an inner portion of the bottom of the foot in the vehicle width direction on the inclined portion 50 to get off the vehicle, downward slipping of the bottom of the foot on the inclined portion 50 can be reduced.

Since the vehicle 100 further includes the upper wall 6, the bottom of the foot is placed on the upper wall 6, and therefore, downward slipping of the bottom of the foot on the inclined portion 50 can be reduced. Specifically, even when the occupant places the inner portion of the bottom of the foot in the vehicle width direction on the inclined portion 50 to get on the vehicle, the remaining portion of the bottom of the foot is placed on the flat upper wall 6, and therefore, a load from the occupant can be easily supported by the flat upper wall 6 and slipping of the foot of the occupant can be prevented.

Since the upper wall 6 includes the upper-wall-side protrusion 63, when the occupant places the bottom of the foot on the inclined portion 50, part of the bottom of the foot is placed on the upper wall 6, and therefore, downward slipping of the bottom of the foot on the inclined portion 50 can be reduced.

Since the shape of the upper-wall-side protrusion 63 is different from the shape of the inclination-side protrusion 51, each of the inclination-side protrusion 51 and the upper-wall-side protrusion 63 can be in a suitable shape. For example, these protrusions can be in a less-slippable shape depending on a wall inclination angle, or may be different from each other in consideration of a design.

Specifically, since the inclination-side protrusion 51 is smaller than the upper-wall-side protrusion 63, the frictional force of the inclination-side protrusion 51 is greater than the frictional force of the upper-wall-side protrusion 63. Since the upper-wall-side protrusion 63 is greater than the inclination-side protrusion 51, a load on the upper-wall-side protrusion 63 can be dispersed and deformation can be easily prevented. Preferably, the upper-wall-side protrusion 63 is long in the front-rear direction, so that the load is easily received at points on the frame bar 25.

Since the upper portion 50b of the inclined portion 50 includes the flat region 50b2 in the lower portion of the upper surface 50c, an upper portion of the foot, which is a portion above a shoe of the occupant in the vehicle, contacts the flat region 50b2, and is less likely to contact the recessed-projecting region 50b1. In other words, since there is no inclination-side protrusion 51 on the lower side of the inner wall 5, contact of the foot with the inclination-side protrusion 51 can be prevented even when the occupant moves the foot toward the inner wall 5 of the floor wall 4 to support one's weight while the vehicle is traveling.

Since the surface of the inclined portion 50 is the texture surface, the foot is less likely to slip when the occupant places the bottom of the foot on the inclined portion 50.

The fastener 3 is located in the recess 52 and is retracted downward as compared to the upper surface 50c of the inclined portion 50. This avoids the occupant from contacting the fastener 3 when getting on and off the vehicle.

Since the fastener 3 is positioned at the upper portion 50b of the inclined portion 50, the upper portion of the foot of the occupant in the vehicle is less likely to contact the fastener 3.

Since the inclined portion 50 includes the ribs 53, 54 on the lower surface 50d, the strength of the inclined portion 50 is improved. This reduces deformation of the inclined portion 50 even when the occupant places the bottom of the foot on the upper surface 50c of the inclined portion 50.

Since the inclined portion 50 includes the ribs 53, 54 (one example of the reinforcement) contacting the frame bar 25, even when the occupant places the bottom of the foot on the upper surface 50c of the inclined portion 50, the inclined portion 50 is supported by the frame bar 25 via the ribs 53, 54, and deformation of the inclined portion 50 is reduced.

Since the surface of the inner wall 5 is less slippable than the surface of the outer wall 7, the foot is less likely to slip when the occupant places the bottom of the foot on the upper surface 50c of the inclined portion 50 of the inner wall 5.

Since the seal surface 71a of the outer wall 7 is positioned outside the frame bar 25 in the vehicle width direction, an internal space below the door 18 can be expanded.

Specifically, in a case where the seal surface 71a overlaps with the frame bar 25 in the up-down direction, or a case where the seal surface 71a is positioned inside the frame bar 25 in the vehicle width direction, the lower portion of the door 18 is located inside in the vehicle width direction, and the internal space below the door 18 is narrowed. In the present disclosure, since the seal surface 71a is located outside the frame bar 25 in the vehicle width direction, the lower portion of the door 18 is located outside in the vehicle width direction, and therefore, the internal space below the door 18 is expanded. In this case, the size of the side sill structure 200 in the vehicle width direction also increases, and it is difficult to move the foot over the side sill structure 200 when the occupant gets on and off the vehicle. However, since the side sill structure 200 has the inclined portion 50, the foot movement path is shortened, and the ease of getting on and off the vehicle is improved.

Since the frame bar 25 is in the cylindrical shape, contact between an upper portion of the frame bar 25 and the upper portion 50b of the inclined portion 50 is prevented, and the upper portion 50b is easily inclined.

Since both the lower portion 50a and the upper portion 50b of the inner wall 5 are inclined, the occupant can more easily get on and off the vehicle as compared to a case of only the upper portion 50b being inclined.

### First Modification

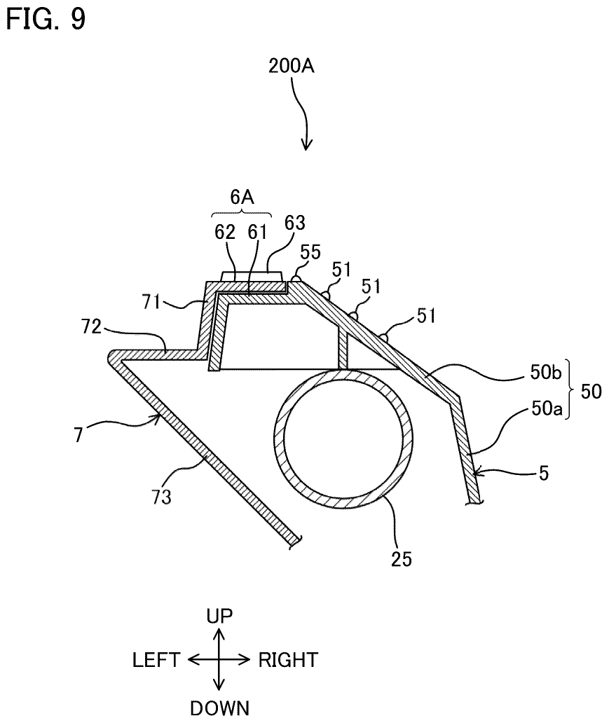

FIG. 9 is a schematic sectional view showing a side sill structure 200A according to a first modification. The side sill structure 200A according to the first modification is different from the side sill structure 200 according to the embodiment in an upper wall 6A. In the first modification, the same reference numerals as those of the embodiment denote the same components as those of the embodiment, and therefore, description thereof will be omitted.

In the side sill structure 200A according to the first modification, the upper wall 6A includes a protrusion 55 in the same shape as that of the inclination-side protrusion 51. Specifically, the upper wall 6A includes the first portion 61 and the second portion 62. The second portion 62 overlaps with the first portion 61 thereabove. Part of the upper surface of the first portion 61 is exposed through the second portion 62. The protrusion 55 is disposed on the exposed portion of the upper surface of the first portion 61. The shape of the protrusion 55 is the same as the shape of the inclination-side protrusion 51.

According to the above-described side sill structure 200A, since the upper wall 6A includes the protrusion 55 in the same shape as that of the inclination-side protrusion 51, part of the bottom of the foot is placed on the upper wall 6A, and therefore, downward slipping of the bottom of the foot on the inclined portion 50 can be reduced.

Since part of the upper surface of the first portion 61 is exposed through the second portion 62, slipping of the bottom of the foot on the upper wall 6A can be reduced in a case where the material of the surface of the first portion 61 is a less-slippable material.

Note that description of other configurations, features, and effects will be omitted, and the description of the side sill structure 200 according to the embodiment can also be used for the description of the side sill structure 200A according to the first modification.

### Other Embodiments

The embodiment has been described above as an example of the technique disclosed in the present application. However, the technique in the present disclosure is not limited to above, and is also applicable to embodiments to which changes, replacements, additions, omissions, and the like are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

The side sill structure 200, 200A is located blow each door 18, but the configurations of the side sill structures 200, 200A corresponding to the doors 18 may be the same as or different from each other.

The inclined portion 50 includes the inclination-side protrusion 51, but does not necessarily include the inclination-side protrusion 51. The shape of the inclination-side protrusion 51 can be changed.

The upper portion 50b of the inclined portion 50 includes the recessed-projecting region 50b1 and the flat region 50b2, but may include only one of the recessed-projecting region 50b1 or the flat region 50b2.

Each of the lower portion 50a and the upper portion 50b of the inclined portion 50 is one portion with a certain inclination, but may include portions with different inclinations.

The surface of the inclined portion 50 is the texture surface, but is not necessarily the texture surface and may be a smooth surface.

The inner wall 5 includes the recess 52 in which the fastener 3 is located, but does not necessarily include the recess 52. In this case, the fastener 3 may be located at the upper surface 50c of the inclined portion 50.

The side sill structure 200 has the upper wall 6, but does not necessarily have the upper wall 6. In this case, the inclined portion 50 may extend to the position of the upper wall 6.

The upper wall 6 includes the first portion 61 and the second portion 62, but may include only one of the first portion 61 or the second portion 62. In a case where the upper wall 6 includes only the first portion 61, the upper-wall-side protrusion 63 is disposed at the first portion 61.

The second portion 62 overlaps with the first portion 61 thereabove, but the first portion 61 may overlap with the second portion 62 thereabove.

The upper wall 6 includes the upper-wall-side protrusion 63, but does not necessarily include the upper-wall-side protrusion 63. The shape of the upper-wall-side protrusion 63 can be changed.

The shape of the upper-wall-side protrusion 63 is different from the shape of the inclination-side protrusion 51, but the shape of the upper-wall-side protrusion 63 may be the same as the shape of the inclination-side protrusion 51.

The seal surface 71a of the outer wall 7 is positioned outside the frame bar 25 in the vehicle width direction, but the seal surface 71a may overlap with the frame bar 25 in the up-down direction or be positioned inside the frame bar 25 in the vehicle width direction.

The inclined portion 50 includes, on the lower surface 50d, the first rib 53 and the second rib 54 extending downward, but may include only one of the first rib 53 or the second rib 54. Alternatively, the inclined portion 50 does not necessarily include the ribs 53, 54.

The reinforcement includes the first rib 53 and the second rib 54, but as the reinforcement, a portion different from the first rib 53 and the second rib 54 may be disposed.

The surface of the inner wall 5 is less slippable than the surface of the outer wall 7, but the material of the surface of the inner wall 5 may be the same as the material of the surface of the outer wall 7.

The floor wall 4, the inner wall 5, the first portion 61 of the upper wall 6, and the flange 64 are integrated into the inner panel, but these parts may be separated from each other.

The outer wall 7 and the second portion 62 of the upper wall 6 are integrated into the outer panel, but these parts may be separated from each other.

The side sill structure 200, 200A of the present disclosure may be applied to a vehicle with no door 18. The seat 17 includes the seats in two lines, but may include seats in one line.

The side sill structure 200, 200A is disposed for each seat 17, specifically for each of the right front, left front, right rear, and left rear seats 17, but the present disclosure is not limited thereto. For example, the side sill structure 200, 200A may be disposed on one of the right and left sides or one of the front and rear sides.

The frame bar 25 is the cylindrical pipe, but may be a rectangular pipe. The inner portion of the upper portion of the frame bar 25 in the vehicle width direction is preferably recessed toward the center of the frame bar 25.

It is only required that at least the upper portion 50b of the inclined portion 50 is inclined, and the lower portion 50a is not necessarily inclined. That is, the upper portion 50b of the inner wall 5 may be inclined outward in the vehicle width direction while extending upward, and the lower portion 50a may extend vertically upward.

The inclination of the upper portion 50b with respect to the horizontal plane is smaller than the inclination of the lower portion 50a with respect to the horizontal plane, but the inclination of the upper portion 50b with respect to the horizontal plane may be the same as the inclination of the lower portion 50a with respect to the horizontal plane.

There is no step between the first portion 61 and the second portion 62 of the upper wall 6, but there may be a step between the first portion 61 and the second portion 62.

The inner wall 5 and the upper wall 6 are made of the synthetic resin material, but may be made of a metal material. With the metal material, abrasion of the protrusion may be prevented, and an antislip effect may be easily maintained.

The technique disclosed here may be applied to an off-road vehicle other than the utility vehicle 100.

### Aspects

The above-described embodiment may be a specific example of the following aspects.

### First Aspect

The utility vehicle 100 (off-road vehicle) includes the seat 17, the floor wall 4 positioned in front of the seat 17, the frame bar 25 at least partially located outside the floor wall 4 in the vehicle width direction and extending in the front-rear direction, and the inner wall 5 covering the frame bar 25 from the inside in the vehicle width direction, the inner wall 5 has the inclined portion 50 standing upward of the floor wall 4, and the inclined portion 50 includes the lower portion 50a and the upper portion 50b located adjacent to the lower portion 50a and extending, as compared to the lower portion 50a, more outward in the vehicle width direction while extending upward.

According to this configuration, when the occupant moves the foot over the inner wall 5 to get on and off the vehicle, the amount of lifting of the foot can be reduced as compared to a case where there is no inclined portion 50. Thus, the foot movement path is shortened, and the ease of getting on and off the vehicle is improved.

### Second Aspect

In the utility vehicle 100 according to the first aspect, the inclined portion 50 at least partially includes the inclination-side protrusion 51 as the recessed-projecting shape. According to this configuration, when the occupant places the bottom of the foot on the inclined portion 50, downward slipping of the bottom of the foot on the inclined portion 50 can be reduced.

### Third Aspect

The utility vehicle 100 according to the first or second aspect further includes the upper wall 6, 6A located adjacent to the outside of the inclined portion 50 in the vehicle width direction and extending horizontally with a smaller inclination than that of the inclined portion 50.

According to this configuration, the bottom of the foot is placed on the upper wall 6, 6A, and therefore, downward slipping of the bottom of the foot on the inclined portion 50 can be reduced.

### Fourth Aspect

In the utility vehicle 100 according to any one of the first to third aspects, the upper wall 6, 6A at last partially includes the upper-wall-side protrusion 63 as the recessed-projecting shape.

According to this configuration, when the occupant places the bottom of the foot on the inclined portion 50, part of the bottom of the foot is placed on the upper wall 6, 6A, and therefore, downward slipping of the bottom of the foot on the inclined portion 50 can be reduced.

### Fifth Aspect

The utility vehicle 100 according to any one of the first to fourth aspects further includes the upper wall 6, 6A located adjacent to the outside of the inclined portion 50 in the vehicle width direction and extending horizontally with a smaller inclination than that of the inclined portion 50, the inclined portion 50 at least partially includes the inclination-side protrusion 51 as the recessed-projecting shape, and the upper wall 6, 6A at least partially includes the upper-wall-side protrusion 63 as the recessed-projecting shape.

According to this configuration, downward slipping of the bottom of the foot on the inclined portion 50 can be reduced.

### Sixth Aspect

In the utility vehicle 100 according to any one of the first to fifth aspects, the shape of the upper-wall-side protrusion 63 is different from the shape of the inclination-side protrusion 51.

According to this configuration, each of the inclination-side protrusion 51 and the upper-wall-side protrusion 63 can be in a suitable shape.

### Seventh Aspect

In the utility vehicle 100 according to any one of the first to sixth aspects, the upper portion 50b of the inclined portion 50 includes the recessed-projecting region 50b1 in the recessed-projecting shape, which is positioned at the upper portion of the upper surface 50c, and the flat region 50b2 flatter than the recessed-projecting region 50b1, which is positioned at the lower portion of the upper surface 50c.

According to this configuration, the upper portion of the foot, which is the portion above the shoe of the occupant in the vehicle, contacts the flat region 50b2, and is less likely to contact the recessed-projecting region 50b1.

### Eighth Aspect

In the utility vehicle 100 according to any one of the first to seventh aspects, the surface of the inclined portion 50 is the texture surface.

According to this configuration, when the occupant places the bottom of the foot on the inclined portion 50, the foot is less likely to slip.

### Ninth Aspect

The utility vehicle 100 according to any one of the first to eighth aspects further includes the fastener 3 fastening the inner wall 5 to the frame bar 25, the inner wall 5 includes the recess 52 recessed downward of the upper surface 50c of the inclined portion 50, and the fastener 3 is located in the recess 52 and is retracted downward of the upper surface 50c of the inclined portion 50.

This configuration avoids the occupant from contacting the fastener 3 when getting on and off the vehicle.

### Tenth Aspect

In the utility vehicle 100 according to any one of the first to ninth aspects, the inclined portion 50 includes, on the lower surface 50d, the ribs 53, 54 extending downward.

According to this configuration, the strength of the inclined portion 50 is improved. This reduces deformation of the inclined portion 50 even when the occupant places the bottom of the foot on the upper surface 50c of the inclined portion 50.

### Eleventh Aspect

In the utility vehicle 100 according to any one of the first to tenth aspects, the inclined portion 50 includes the ribs 53, 54 (one example of the reinforcement) contacting the frame bar 25 from above.

According to this configuration, deformation of the inclined portion 50 is reduced even when the occupant places the bottom of the foot on the upper surface 50c of the inclined portion 50.

### Twelfth Aspect

The utility vehicle 100 according to any one of the first to eleventh aspects further includes the outer wall 7 covering the frame bar 25 from the outside in the vehicle width direction, and the surface of the inner wall 5 is less slippable than the surface of the outer wall 7.

According to this configuration, the foot is less likely to slip when the occupant places the bottom of the foot on the upper surface 50c of the inclined portion 50 of the inner wall 5.

### Thirteenth Aspect

The utility vehicle 100 according to any one of the first to twelfth aspects further includes the door 18 positioned outside the inner wall 5 in the vehicle width direction, and the outer wall 7 covering the frame bar 25 from the outside in the vehicle width direction, the outer wall 7 has the seal surface 71a seal-contacting the door 18 in a state of the door 18 being closed, and the seal surface 71a is positioned outside the frame bar 25 in the vehicle width direction.

According to this configuration, the internal space below the door 18 can be expanded.

### Fourteenth Aspect

The side sill structure 200, 200A is the side sill structure covering the frame bar 25 at least partially located outside the floor wall 4 in the vehicle width direction and extending in the front-rear direction. The side sill structure includes the inner wall 5 covering the frame bar 25 from the inside in the vehicle width direction, the inner wall 5 has the inclined portion 50 standing upward of the floor wall 4, and the inclined portion 50 includes the lower portion 50a and the upper portion 50b located adjacent to the lower portion 50a and extending, as compared to the lower portion 50a, more outward in the vehicle width direction while extending upward.

According to this configuration, when the occupant moves the foot over the inner wall 5 to get on and off the vehicle, the amount of lifting of the foot can be reduced as compared to a case where there is no inclined portion 50. Thus, the foot movement path is shortened, and the ease of getting on and off the vehicle is improved.

What is claimed:

1. An off-road vehicle comprising:
a seat;
a floor wall positioned in front of the seat;
a frame bar at least partially located outside the floor wall in a vehicle width direction and extending in a front-rear direction; and
an inner wall covering the frame bar from an inside in the vehicle width direction,
wherein the inner wall has an inclined portion standing upward of the floor wall, and
the inclined portion includes a lower portion and an upper portion located adjacent to the lower portion and extending, as compared to the lower portion, more outward in the vehicle width direction while extending upward.

2. The off-road vehicle according to claim 1, wherein
the inclined portion at least partially includes an inclination-side protrusion as a recessed-projecting shape.

3. The off-road vehicle according to claim 1, further comprising:
an upper wall located adjacent to the outside of the inclined portion in the vehicle width direction and extending horizontally with a smaller inclination than that of the inclined portion.

4. The off-road vehicle according to claim 3, wherein
the upper wall at last partially includes an upper-wall-side protrusion as a recessed-projecting shape.

5. The off-road vehicle according to claim 1, further comprising:
an upper wall located adjacent to the outside of the inclined portion in the vehicle width direction and extending horizontally with a smaller inclination than that of the inclined portion,
wherein the inclined portion at least partially includes an inclination-side protrusion as a recessed-projecting shape, and
the upper wall at least partially includes an upper-wall-side protrusion as a recessed-projecting shape.

6. The off-road vehicle according to claim 5, wherein
a shape of the upper-wall-side protrusion is different from a shape of the inclination-side protrusion.

7. The off-road vehicle according to claim 1, wherein
an upper portion of the inclined portion includes a recessed-projecting region in a recessed-projecting shape, which is positioned at an upper portion of an upper surface, and a flat region flatter than the recessed-projecting region, which is positioned at a lower portion of the upper surface.

8. The off-road vehicle according to claim 1, wherein
a surface of the inclined portion is a texture surface.

9. The off-road vehicle according to claim 1, further comprising:
a fastener fastening the inner wall to the frame bar,
wherein the inner wall includes a recess recessed downward of the upper surface of the inclined portion, and
the fastener is located in the recess, and is retracted downward of the upper surface of the inclined portion.

10. The off-road vehicle according to claim 1, wherein
the inclined portion includes, on a lower surface thereof, a rib extending downward.

11. The off-road vehicle according to claim 1, wherein
the inclined portion includes a reinforcement contacting the frame bar from above.

12. The off-road vehicle according to claim 1, further comprising:
an outer wall covering the frame bar from the outside in the vehicle width direction,
wherein a surface of the inner wall is less slippable than a surface of the outer wall.

13. The off-road vehicle according to claim 1, further comprising:
a door positioned outside the inner wall in the vehicle width direction; and
an outer wall covering the frame bar from the outside in the vehicle width direction,
wherein the outer wall has a seal surface seal-contacting the door in a state of the door being closed, and the seal surface is positioned outside the frame bar in the vehicle width direction.

14. A side sill structure covering a frame bar at least partially located outside a floor wall in a vehicle width direction and extending in a front-rear direction, comprising:
an inner wall covering the frame bar from an inside in the vehicle width direction,
wherein the inner wall has an inclined portion standing upward of the floor wall, and
the inclined portion includes a lower portion and an upper portion located adjacent to the lower portion and extending, as compared to the lower portion, more outward in the vehicle width direction while extending upward.
